(19) United States
(12) Patent Application Publication
(10) Pub. No.: US 2019/0099706 A1
(43) Pub. Date: Apr. 4, 2019

(54) INTEGRATED SYSTEM FOR SEAWATER SCRUBBING OF MARINE EXHAUST GAS

(71) Applicant: Chevron U.S.A. Inc., San Ramon, CA (US)

(72) Inventor: Vijay R. Sampath, San Ramon, CA (US)

(21) Appl. No.: 16/140,657

(22) Filed: Sep. 25, 2018

Related U.S. Application Data
(60) Provisional application No. 62/566,622, filed on Oct. 2, 2017.

(51) Int. Cl. B01D 47/10; B01D 53/50; B01D 53/92; F01N 3/04; F01N 3/08

(52) U.S. Cl. CPC B01D 47/10; B01D 53/504; B01D 53/92; F01N 3/04; F01N 2610/1453; B01D 2252/1035; B01D 2257/302; F01N 2570/04; F01N 3/085

(57) ABSTRACT

An integrated system for onboard scrubbing of a marine exhaust gas on a ship, comprising:
a) a Venturi quencher having:
   i) two liquid inlets that feed quench water to the Venturi quencher; and
   ii) a hot exhaust gas entry that feeds the hot marine exhaust gas from an engine on the ship; and
b) the rotating packed bed device, having:
   iii) a stationary gas distributor, placed along an outer circumference of the RPB device, that disengages a quenched marine exhaust gas from a cooled two-phase mixture, and uniformly distributes the quenched marine exhaust gas along the outer circumference of the RPB device; and
   iv) a stationary liquid distributor, centrally positioned, and with multiple liquid rings that are fitted with spray nozzles that spray a seawater along an inner circumference of the RPB device. Also, processes for using the integrated system, and a ship comprising the integrated system.

### TECHNICAL FIELD

This application is directed to integrated systems having a Venturi quencher and a rotating packed bed device, and processes using the integrated systems, for removing sulfur oxide contaminants from marine exhaust gas onboard of ships.

### BACKGROUND

Combustion of 3.5 wt % high-sulfur bunker fuel oil in marine two- and four-stroke diesel engines generates sulfur dioxide emissions that can lead to acid rain and is an environmental hazard. International Maritime Organization (IMO) has mandated use of 0.5 wt % Low-sulfur bunker fuel starting October 2020 or equivalent emission reductions. One of the equivalent solutions to 0.5 wt % sulfur fuel is to continue to burn 3.5 wt % Sulfur bunker fuel in two-stroke and four-stroke marine diesel engines and then scrub out the sulfur oxides from the marine exhaust gas to meet the equivalent of 0.5 wt % sulfur fuel use. While many dry and wet flue gas scrubbing processes have been demonstrated commercially to remove up to 98% of the sulfur oxides present in marine exhaust gas, seawater scrubbing emerges as a natural solution on board a ship due to its low cost, ample availability, alkalinity (pH˜8), ease of use, and demonstrated performance record over fifty years on land-based applications.

The shipping industry has gravitated towards the seawater spray tower as the ideal contacting device for scrubbing SO₂ on board a ship. This is a low pressure drop gas-liquid contacting device that can be used for both, quenching the hot gas as well as subsequently scrubbing SO₂ from the cooled gas. Spray towers must be quite tall to achieve 98% sulfur removal with seawater. The primary challenge to spray towers is space constraint on board a ship. These towers are tall, require considerable footprint, and cannot always be retrofitted inside the funnel of the ship. The adoption of seawater scrubbing to meet the mandated IMO specification has not progressed as rapidly as anticipated.

To address this space constraint, U.S. Patent Application 62/520,660 disclosed a compact rotating packed bed (RPB) device for scrubbing Marine Exhaust Gas (MEG) with seawater to meet the IMO mandated specification while burning 3.5 wt % High Sulfur Fuel Oil. RPB devices were introduced in the 1970s as compact mass transfer devices that enable intense gas-liquid micro-mixing. This intensive gas-liquid contacting is accomplished by flows of gas and liquid across the packing material in a RPB device. The centrifugal forces, unleashed by the rotation, shear the liquid film into fine droplets, thereby creating a large surface area for gas-liquid mass transfer. The high gravity forces in the RPB device dramatically shrink the Height Equivalent of a Transfer Unit (HETU), by an order of magnitude, so that the same separation can be accomplished by the RPB device with a smaller footprint relative to a conventional column.

Notwithstanding the strong claims for performance of RPB devices, they have found industry application in only a handful of instances over several decades since their invention. This reluctance may be attributed to power consumption and reliability concerns about rotating equipment. In the limited number of situations where space is a major constraint, investors have chosen to settle for the certainty of gravity flow columns (or spray columns) over the novelty of RPB devices.

### SUMMARY

Provided herein is an integrated system for onboard scrubbing of a marine exhaust gas on a ship, comprising:
a) a Venturi quencher having:
   i) two liquid inlets that feed a quench water to the Venturi quencher, wherein a first liquid inlet connects to a spent seawater recycle line that feeds the quench water that is comprised of a recycled water from a spent seawater sump of a rotating packed bed device and wherein a second liquid inlet connects to a fresh seawater supply line that feeds the quench water that comprises a fresh seawater; and
   ii) a hot exhaust gas entry that feeds the marine exhaust gas, having a temperature greater than 180° C., from an engine on the ship; and
b) the rotating packed bed device, having:
   iii) a stationary gas distributor, placed along an outer circumference of the rotating packed bed device, connected to the Venturi quencher, wherein the stationary gas distributor is configured to receive a cooled two-phase mixture of the marine exhaust gas and the quench water from the Venturi quencher, disengage a quenched marine exhaust gas from the cooled two-phase mixture, and uniformly distribute the quenched marine exhaust gas along the outer circumference of the rotating packed bed device; and
   iv) a stationary liquid distributor, with multiple liquid rings, that is centrally positioned within the rotating packed bed device, wherein the multiple liquid rings are fitted with spray nozzles that spray a seawater along an inner circumference of the rotating packed bed device.

Also provided herein is a process for onboard scrubbing of the marine exhaust gas on the ship, comprising feeding the marine exhaust gas to the integrated systems disclosed herein and discharging to an atmosphere a discharged gas that has been scrubbed onboard the ship.

Additionally, provided herein is a marine ship comprising one or more of the integrated systems for onboard scrubbing of the marine exhaust gas that are described in this disclosure.

The present invention may suitably comprise, consist of, or consist essentially of, the claims and embodiments, as described herein.

### BRIEF DESCRIPTION OF THE DRAWINGS

FIG. 1 is a schematic block flow diagram of one embodiment of the integrated system of this invention.

FIG. 2 is an exemplary embodiment of a Venturi quencher that can be used in this invention.

FIG. 3A is an exemplary schematic arrangement of a Venturi quencher and a rotating packed bed device.

FIG. 3B-1 is an exemplary schematic of a top plan view of a RPB device with a circumferential skirt that tangentially distributes a quenched marine exhaust gas, from a Venturi quencher, along the outer circumference of the rotating packed bed device.

FIG. 3B-2 is an alternative view of the exemplary schematic of a RPB device with a circumferential skirt.

FIG. 4 is one exemplary embodiment of the system of this invention utilizing tangential gas entry of a quenched marine exhaust gas in a rotating packed bed device.

FIG. 5A is an elevation view of embodiment of a stationary liquid distributor design having multiple liquid-filled rings fitted with multiple nozzles.

FIG. 5B is a top plan view of one of the multiple liquid rings in an exemplary stationary liquid distributor.

FIG. 6 is an example of a demister pad that can be fitted at the top of a RPB device to remove entrained moisture from discharged gas.

FIG. 7 is an example of a circular mist eliminator fitted with steam coils that can be fitted at the top of a RPB device to restore buoyancy to discharged gas.

### DETAILED DESCRIPTION

The integrated system and processes using the integrated system disclosed herein are carefully crafted to ensure the overall integrated system, besides being compact, is reliable, efficient, and fit-for-purpose for the marine shipping industry. This current disclosure uniquely integrates a RPB device with various unit operations associated with on-board scrubbing of marine exhaust gas (MEG) to meet IMO equivalent specifications. Given the space constraint, the unit operations in the MEG loop are tightly integrated into a compact whole.

Marine exhaust gas leaving an engine on a ship is typically hot, having a temperature greater than 180° C., or ranging in temperature from 200° C. to 390° C. The temperature of the marine exhaust gas can vary depending on whether an Energy Economizer is employed in the gas loop, whether the engine is a two or four-stroke engine, or whether the engine is operating at full or part-load. The integrated system of this disclosure comprises a Venturi quencher that cools the hot marine exhaust gas to a lower temperature, which is needed to more effectively dissolve sulfur oxides into the quench water or the seawater. The Venturi quencher quickly produces the cooled two-phase mixture of the marine exhaust gas and the quench water. In one embodiment, the cooled two-phase mixture has a lower temperature from about 10° C. to about 50° C., or from about 20° C. to 25° C.

In one embodiment, the Venturi quencher is configured to contact the hot marine exhaust gas at high velocity, through a throat of the Venturi quencher, with fine droplets of the quench water. The cooling happens very quickly. In one embodiment, the cooling of the hot marine exhaust gas can occur instantaneously, i.e., within 0.1 to 10.0 seconds, in a throat of the Venturi quencher.

Marine exhaust gas leaving an engine on a ship can comprise contaminants that originate from partial combustion of hydrocarbons or were originally present in the fuel being combusted in the marine engine. These contaminants can include sulfur oxides, nitrogen oxides, soot, ash particulates, and metals. Some of the contaminants can be particulates.

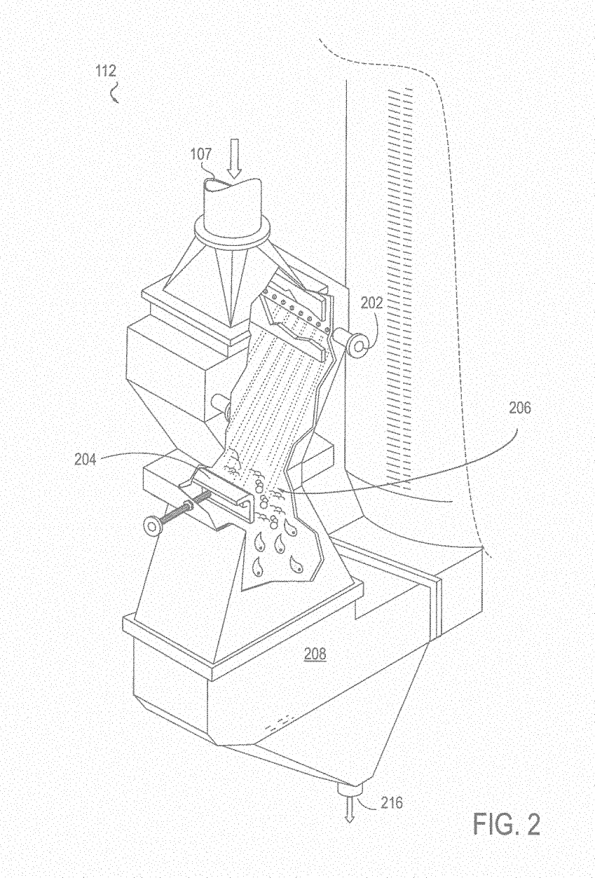

In one embodiment, particulates in the marine exhaust gas are collected in the quench water and removed from the quenched marine exhaust gas. In one embodiment, the Venturi quencher is configured with a liquid inlet that creates one or more sprays of the quench water along an upper converging section of the Venturi quencher. An example of this embodiment is shown in FIG. 2. In embodiments with the spray of the quench water along an upper converging section of the Venturi quencher, a layer of the quench water protects the walls of the Venturi quencher from direct impingement by the particulates while also removing the particulates from the exhaust gas.

In one embodiment, the Venturi quencher is a wetted-wall Venturi quencher that operates as a quench unit and can be a compact solution for cooling a hot marine exhaust gas and removing soot and particulates from the hot marine exhaust gas. By removing particulates greater than 3 microns, the quench unit can protect the packing in the RPB device from fouling by soot and particulates and enable effective SO₂ scrubbing in the RPB device.

In one embodiment, the quench water used in the Venturi quencher can be fresh seawater, recycled seawater, oxidized seawater, seawater withdrawn from a spent seawater sump of the RPB device, or combinations thereof.

In one embodiment, the spent seawater recycle line recycles a portion of the spent water, as recycled water from the spent seawater sump, to the front of the Venturi quencher for quench cooling. Using recycled water from the spent seawater sump can significantly reduce the volume of fresh seawater needed for quenching and sulfur oxide removal.

In one embodiment, the integrated system maximizes a cascade of the recycled water from the spent seawater sump through the Venturi quencher and minimizes the use of the fresh seawater in the Venturi quencher. In one embodiment, a cascade of the recycled water from the spent seawater sump through the Venturi quencher is maximized and the fresh seawater is used principally for controlling a level of liquid collected in the spent seawater sump. In one embodiment, the Venturi quencher is configured to cause the marine exhaust gas to contact the recycled water before the marine exhaust gas is contacted by the fresh seawater.

In one embodiment, the Venturi quencher is configured to handle large volumetric flows, which are common on many large ships. In one embodiment, the Venturi quencher is rectangular and handles volumetric flows through the Venturi quencher greater than 88,000 actual-cubic-feet-per-minute (ACFM). In one embodiment, the Venturi quencher is configured to handle volumes of marine exhaust gas that vary over a broad range. One configuration that handles varied volumes of marine exhaust gas, also shown in FIG. 2, is a Venturi quencher comprising a variable sized throat. One means to configure a variable sized throat is to include a moveable plate or other orifice that can be adjusted or even automatically manipulated to follow or meet the needs from the varied volumes of marine exhaust gas being supplied to the Venturi quencher. In the embodiment shown in FIG. 2., the Venturi quencher is rectangular and comprises a variable sized throat.

In one embodiment, the Venturi quencher can comprise a flooded elbow that connects to the RPB device and provides a tangential entry of the cooled two-phase mixture into the circumferential gas distributor. In one embodiment, the flooded elbow is at the bottom of the Venturi quencher and the flooded elbow is fitted with a liquid seal. The liquid seal minimizes erosion that could occur due to impingement by particulates in the Venturi quencher. Further, provision of a small outlet for a bleed stream, from the bottom of the flooded elbow, that removes particulate build-up can be included. In one embodiment, the Venturi quencher has a conical bottom on the flooded elbow with a bottom drain that can be a liquid slurry drain outlet. In one embodiment the integrated system additionally comprises a bottom drain on the Venturi quencher that drains a slipstream of particulates and liquid from a bottom of a flooded elbow of the Venturi quencher.

The Venturi quencher is connected to the RPB device. In one embodiment, the connection between the Venturi quencher and the RPB device utilizes a tangential gas entry. In one embodiment, that tangential gas entry provides a cyclonic action that disengages the quenched marine exhaust gas from the quench water. The tangential gas entry minimizes maldistribution of the quenched marine exhaust gas in the RPB device. Gas maldistribution in RPB devices is described in Llerna-Chavez and Larachi, Chem Eng Sci, 64 (2009), 2113. In one embodiment, the design of the tangential gas entry is such that the gas flow direction is co-current with a rotating direction of a rotation of the RPB device.

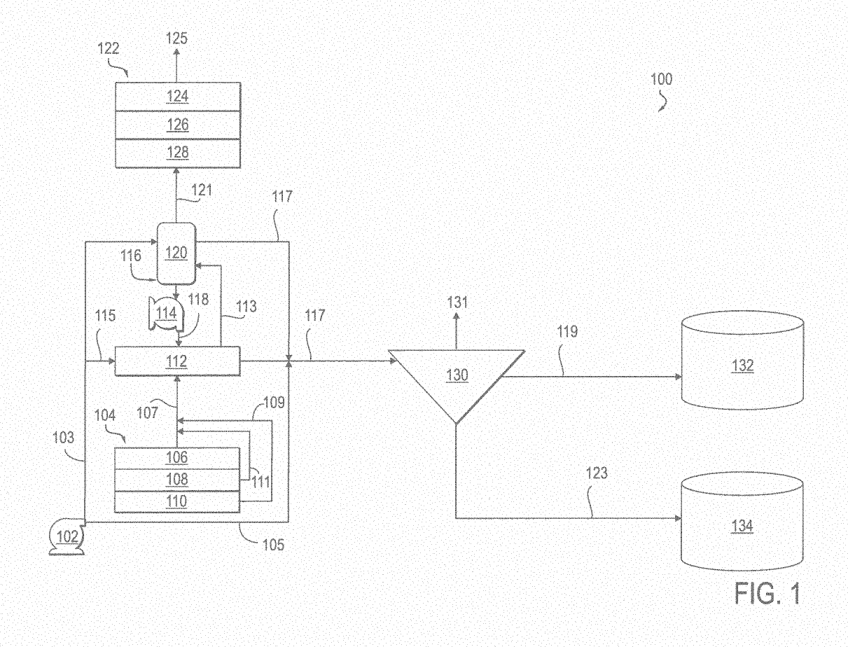

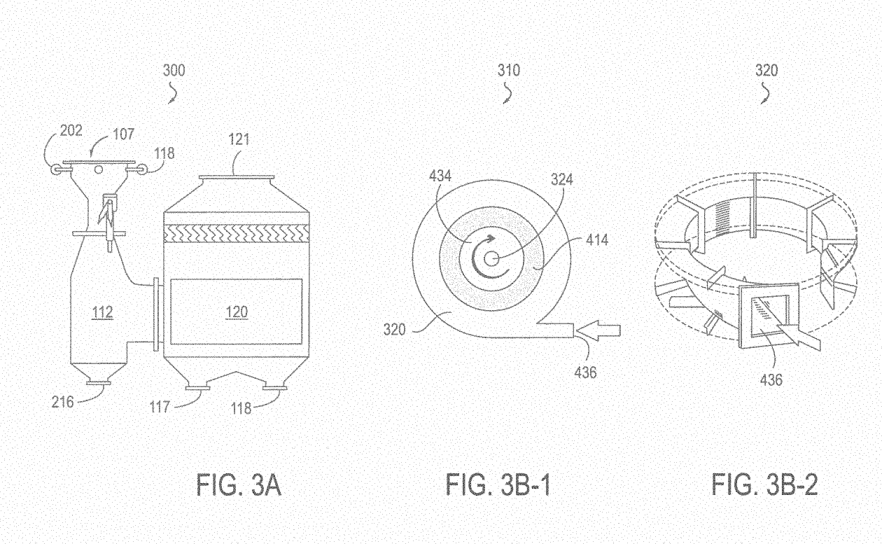

The RPB device has a circumferential gas distributor, connected to the Venturi quencher. The circumferential gas distributor is configured to receive a cooled two-phase mixture of the marine exhaust gas and the quench water from the Venturi quencher, disengage a quenched marine exhaust gas from the cooled two-phase mixture, and distribute the quenched marine exhaust gas along an outer circumference of the RPB device. In one embodiment, the circumferential gas distributor is an elongated skirt or blade that causes the quench water to drop out of the cooled two-phase mixture, such as to a spent seawater sump, while the quenched marine exhaust gas is raised from the bottom of the elongated skirt or blade to enter a packed bed in the RPB device. FIG. 3B-1 shows one embodiment of a circumferential gas distributor that is an elongated skirt that could be used.

In one embodiment, the circumferential gas distributor is configured to evenly distribute the quenched marine exhaust gas across the 360-degree circumference of the RPB device. In one embodiment, the circumferential gas distributor is shaped and sized such that it segregates the quench water containing soot and particulates from the packing material in the RPB device, to prevent fouling of the packing material and extend the life of the RPB device. In one embodiment, the circumferential gas distributor drops out the quench water to a spent seawater sump in the RPB device. In some embodiments, the elongated skirt is used as the circumferential gas distributor and all the benefits described in this paragraph are obtained.

In one embodiment, the stationary gas distributor extends along a majority of the outer circumference of the RPB device and is an elongated skirt that causes the quench water to drop out of the cooled two-phase mixture while the quenched marine exhaust gas is raised up and enters a packing in a packed bed in the RPB device.

In one embodiment, the RPB device utilizes the seawater to effectively remove contaminants, including SO₂, from the marine exhaust gas, such that a discharged gas meets IMO mandated specifications. The seawater can be fresh seawater, or the seawater may also comprise an alkali. In one embodiment, the seawater is fresh cold seawater. In one embodiment the RPB device removes sulfur oxides, e.g., SO₂ and SO₃ such that the discharged gas is equivalent to the emissions from burning fuel containing from zero to less than 0.5 wt % sulfur. In one embodiment, the discharged gas comprises less than half of the sulfur, such as from zero to 30% of the sulfur, that was originally present in the marine exhaust gas before entry into the Venturi quencher. Examples of suitable RPB devices are taught in U.S. Provisional Patent Application No. 62/520,660.

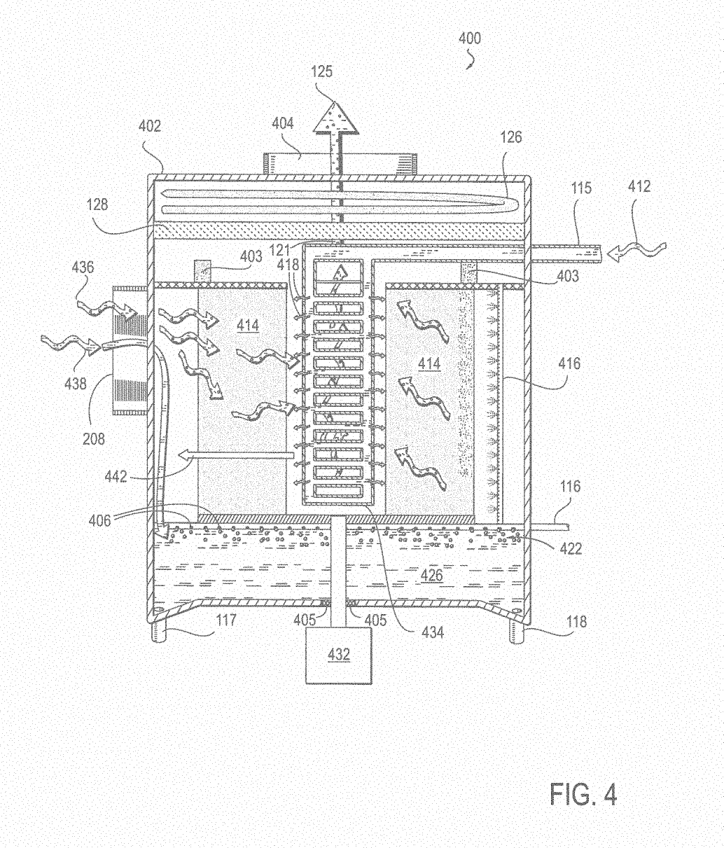

In one embodiment, the RPB device comprises a motor drive at one end that rotates a packed bed that is fixed to a rotating shaft within the RPB device. In one embodiment, the motor drive is at the bottom of the RPB device. This embodiment is shown in FIG. 4. FIG. 4 shows an embodiment wherein the rotating shaft supports the bottom of a packed bed but does not go through the eye of the RPB device. In this embodiment, the outer periphery of the packed bed in the RPB device is steadied and supported by a set of bearings at the top of the RPB device that keep the packed bed centered at the top. In this embodiment, one or more roller bearings support the rotating shaft above the motor drive, as shown in FIG. 4. Bearings can be placed as shown in FIG. 4.

In one embodiment, a rotating shaft in the RPB device is supported at opposite ends of the RPB device with roller bearings. In one embodiment, the rotating shaft in the RPB device is supported at both the top and the bottom of the RPB device by roller bearings, with a motor drive at the bottom. However, the motor drive could also be located on the top of the RPB device without compromising the effectiveness of the integrated system.

Unlike spray towers, RPB devices are characterized by a high degree of micro-mixing and very short holdup times of gas and liquid. In the RPB device the chemical reactions to scrub the sulfur oxides from the marine exhaust gas are very fast. However, the bisulfites and sulfites that are formed during the scrubbing in the Venturi quencher or the RPB device can reverse and produce sulfur oxides again. Sulfites are compounds that contain the sulfite ion, SO₂⁻. Bisulfites are compounds that contain the bisulfate ion, HSO₃⁻. These reverse reactions can result in unacceptable sulfur oxide (e.g., sulfur dioxide) emissions from the ship. In one embodiment, these reverse reactions, outside of the RPB device, are forestalled by aerating a liquid effluent from the RPB device and/or the quench water from the Venturi quencher by converting the bisulfites and/or the sulfites into stable sulfates in the liquid effluent.

In one embodiment, the RPB device can additionally comprise a spent seawater sump, at the bottom of the RPB device, that is well-aerated and oxidizes sulfur and sulfur compounds that are collected from either or both of a quench water from the Venturi quencher or a liquid effluent from the RPB device. One example of a spent seawater sump is shown in FIG. 4. In one embodiment, the spent seawater sump is sized to provide sufficient residence time for the stable sulfates to form in the collected effluents from the RPB device and/or the Venturi quencher. In one embodiment, air is provided to the spent seawater sump by blowing, for example with a fan, an air sparger, or with a rotating fan with an air sparger. In one embodiment, the quench water from the Venturi quencher and the liquid effluent from the RPB device drop by gravity to the spent seawater sump. Oxidizing the sulfur and sulfur compounds makes them more stable and suitable for discharge, disposal, or recycle to the Venturi quencher.

In one embodiment, oxidizing the sulfur and sulfur compounds in the spent seawater sump enables the spent seawater to be recycled and more effectively used in the Venturi quencher. When the recycled water from the spent seawater sump is passed through the Venturi quencher, the recycled water is heated, and stable sulfates are retained in the recycled water that is heated rather than being released to the atmosphere.

The aeration in the spent seawater sump can reduce the chemical oxygen demand (COD) upon discharge of a wastewater from the integrated system. In one embodiment the COD of the wastewater after aerating in the spent seawater sump can be reduced to below 1500 mg/l. In one embodiment, carbon dioxide is formed in the liquids collected in the spent seawater sump. The carbon dioxide formed in the spent seawater sump can be passed through the RPB device, along with nitrogen from air, and exit with clean exhaust gas (discharged gas) from the ship to the atmosphere. Atmosphere is defined herein as the ambient mixture of gases that surround the earth and which exist outside of the ship.

In one embodiment, the integrated system additionally comprises a spent seawater sump that is provided with an air supply line through which air is sparged into collected liquids, and the spent seawater sump collects the quench water from the Venturi quencher, an effluent liquid from the rotating packed bed device, or a combination thereof, and the spent seawater sump creates stable sulfates in the collected liquids in the spent seawater sump. There can be insufficient oxygen in flue gas to completely oxidize SO₃²⁻ to SO₄²⁻. Sparging air into the seawater that collects in the spent seawater sump helps to stabilize the sulfur that is present as sulfates prior to discharge of the spent seawater effluent or recycling of the spent seawater to the Venturi quencher. Sparging air also minimizes COD in the spent seawater effluent.

In one embodiment, additional fresh seawater can be blended into a liquid effluent from the RPB device or from the spent seawater sump of the RPB device. The additional seawater can neutralize any residual acid in the liquid effluent and meet a target pH of between 6 and 10, or a target pH of 6.5 or greater.

In one embodiment, the liquid effluent from the RPB device or a blended mixture of the liquid effluent with fresh seawater can be routed to a separator that is connected to the RPB device. In one embodiment, the separator can be a centrifuge or a cyclone separator. The separator can be configured to separate the liquid effluent or the blended mixture into two streams: i) an overhead effluent clean seawater stream that can be discharged to the ocean, and ii) a bottom sludge that can be collected in a holding tank on the ship, for discharge at an upcoming port. In one embodiment, the separator can also have provision for air blown into it via an air sparger, and can also comprise a vent that emits carbon dioxide, or small amounts of other light gases.

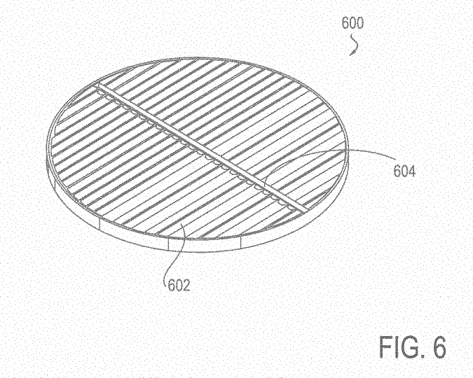

The RPB device has a gas outlet for discharging a scrubbed marine exhaust gas. In one embodiment, the gas outlet passes to a fan that disperses the scrubbed marine exhaust gas to the atmosphere. The scrubbed marine exhaust gas can contain entrained moisture. In one embodiment, the integrated system additionally comprises one or more mist eliminators fitted at the gas outlet, e.g., at the top, of the RPB device. In one embodiment, the mist eliminator is a demister pad. The demister pad can be configured to trap and condense entrained water from discharged gas from the RPB device and prevent a visible plume of gas from the ship. In one embodiment, the discharged gas does not have a visible plume. In one embodiment, the demister pad is a vane-type circular demister pad that is fitted onto a circular gas outlet from the RPB device. One exemplary-demister pad (600), a circular demister pad, is shown in FIG. 6.

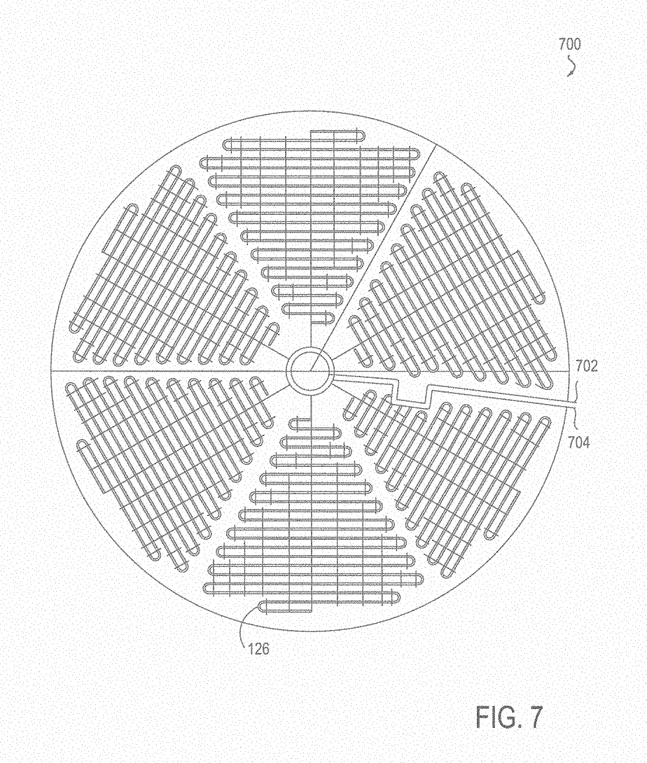

In one embodiment, the mist eliminator comprises steam coils and the steam coils warm the discharged gas and provide buoyancy to the discharged gas. In one embodiment, the integrated system comprises a mist eliminator having a set of circular steam coils. An example of a circular mist eliminator with multiple steam coils is shown in FIG. 7. In one embodiment, as shown in FIG. 1, the integrated system can comprise a vane-type demister pad, followed by a mist eliminator having a set of circular steam coils. In one embodiment, the one or more mist eliminators comprise a demister pad and steam coils.

In one embodiment, the integrated system additionally comprises a Continuous Emissions Monitoring System (CEMS) module that confirms the effective operation of the integrated system of this invention. In one embodiment, when the CEMS module confirms the effective operation of the integrated system, the discharged gas from the integrated system can be vented directly to the atmosphere. For example, the CEMS module can confirm that the discharged gas is a desulfurized flue gas meeting environmental limits on sulfur. In one embodiment, the venting is enabled by an induced draft exhaust fan that can be fluidly connected to the gas outlet on the top of the RPB device.

In one embodiment, as shown in FIG. 1, there are two interacting loops: i) an exhaust gas loop, and ii) a water (or liquid) loop. The gas loop in FIG. 1 comprises the RPB device and the Venturi quencher that operates as a quench unit. Both the RPB device and Venturi quencher are compact devices that can fit easily onto a ship and meet the space and pressure drop considerations that are unique to a ship. The water loop in FIG. 1 comprises a fresh seawater pump, lines that conduct seawater from the fresh seawater pump to one or more of the Venturi quencher, the RPB device, a combined water effluent line from the RPB device and the Venturi quencher. The combined water effluent line from RPB device and the Venturi quencher is routed to a cyclone separator along with fresh seawater to control the pH in the cyclone separator. The cyclone separator yields two streams, an overhead effluent stream for discharge to the ocean and a bottom sludge that is collected in a holding tank. In one embodiment, the integrated system can have a hybrid design with both open and closed loops.

In one embodiment, the marine exhaust gas, having a temperature greater than 180° C., can be aggregated from multiple engines and a boiler on the ship.

Hydrodynamic studies with RPB devices reported in Yan, Lin & Ruan, I&EC Res, 2012, 51, 10472 have shown that not all of the packing area in a packed bed of a RPB device is equally wetted or equally efficient for mass-transfer. An entry region, a narrow circumferential zone that is close to the center eye of the RPB device, sees more intense gas-liquid contact. The center eye is defined herein as the space in the center of the RPB device without any packing material. If care is not taken, the outer periphery of the packing bed in the RPB device can be a completely dry region and not function to reduce contaminants and perform effective onboard scrubbing of a marine exhaust gas. This feature can be more pronounced as the size of the RPB device increases. Guo, Wen, Zhao, Wang, Zhang, Li & Qian (Eniron. Eng. Sci Technol., 2014, 48, 6844) evaluated the optimum packing thickness at different revolutions per minute and liquid jet velocities and concluded that not all sections of the packing are equally effective for mass transfer. They further noted that the mass-transfer effectiveness drops off towards the outer layers, leading to an optimum packing thickness.

In one embodiment, the RPB device has a ratio of an outer diameter to an inner diameter of a packed bed in the RPB device that provides good counter-current mass-transfer between the quenched marine exhaust gas and seawater across the depth of the packed bed. In one embodiment, the ratio of the outer diameter to the inner diameter of the packed bed in the RPB device is 2.3:1 or less. Surprisingly, the gas-liquid mass transfer rates between the quenched marine exhaust gas and the seawater are very fast and this design limitation is readily achievable and provides for effective onboard scrubbing of a marine exhaust gas on a ship using seawater.

Pan and Chiang (Journal of Cleaner Production, 149 (2017), 540-556) make the point that a RPB is even more effective than wet scrubbers, such as Venturi quenchers, in trapping soot and fine particulates from flue gas. In one embodiment, the Venturi quencher and the RPB device in the integrated system are both configured to remove particulates from gas flows within the integrated system and to produce a discharged gas with minimal to no particulates. In one embodiment, the Venturi quencher traps particulates larger than 3 microns in average diameter; and the RPB device comprises packing material that traps sub-micron particulates up to 0.1 micron in average diameter as well as any particulates between these two ranges. In one embodiment, the outer diameter of the packed bed in the RPB device is sized to provide a large surface area in an outer periphery that provides the trapping of sub-micron particulates for an extended time without causing an excessive pressure-drop in the RPB device.

In one embodiment, a bulk of sulfur oxide contaminants (e.g., sulfur dioxide) mass transfer between the quenched marine exhaust gas and the seawater occurs in the inner areas of the packed bed, closer to the center eye, and a second bulk of the trapping of the sub-micron particulates occurs in the outer areas of the packed bed, farther from the center eye.

In one embodiment, the RPB device comprises a wash inlet that feeds a wash solution to the outer areas of the packed bed. In one embodiment, a wash inlet on the RPB device can periodically spray a wash solution into the RPB device that loosens soot and particulates lodged on an outer periphery of the packing material in the RPB device, which drop into a spent seawater sump in the RPB device. An example of a wash solution that could be used is a solution of ammonium citrate. Other solutions that might be employed include: detergent mixtures, petroleum distillates (alone or in emulsions), xylene emulsions, ethanol, ethylene glycol monobutyl ether, and combinations thereof. In one embodiment, the wash inlet can comprise one or more nozzles or sprayers. In one embodiment, a rotation of the packed bed in the RPB device ensures that all the packed bed surface area on an outer periphery gets sprayed with a wash solution that removes soot or particulates. In one embodiment the RPB device comprises a wash water supply system.

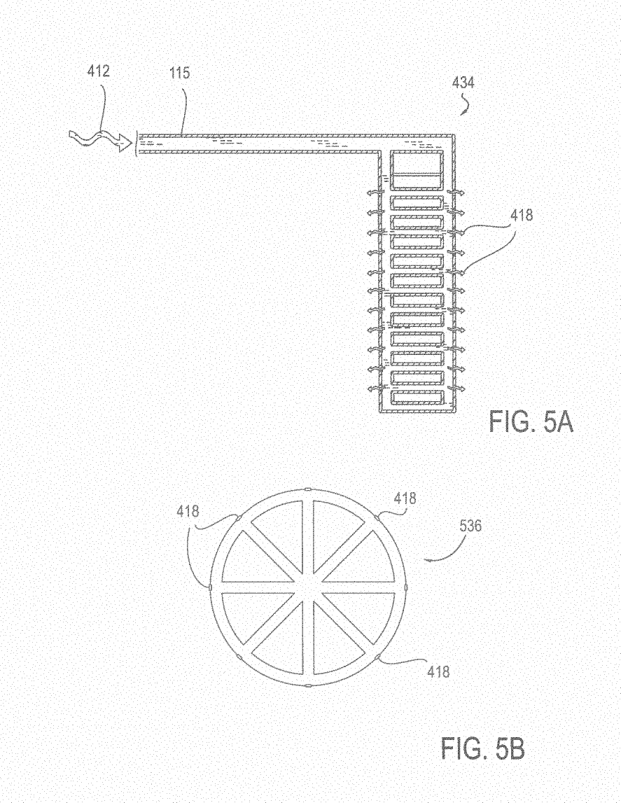

The integrated system includes a stationary liquid distributor with multiple spray nozzles that feed a seawater across an inner circumference of the RPB device. In one embodiment, the seawater is fresh seawater, such as fresh cold seawater. An example of this type of stationary liquid distributor is shown in FIG. 5A. In one embodiment the stationary liquid distributor fits neatly within the center eye of the RPB device and directs the seawater outwardly towards the packed bed in the RPB device. The multiple spray nozzles are arranged to provide uniform seawater distribution to all the packing material in the RPB device. In one embodiment, the stationary liquid distributor is held stationary in the eye of the RPB device. In one embodiment, the stationary liquid distributor comprises multiple liquid rings, spaced evenly apart, with each ring comprising spray nozzles. The spacing can be designed to fit the size of the RPB device, and can be from about 5 centimeters to 30 centimeters. In one embodiment, the stationary liquid distributor comprises multiple liquid rings with spray nozzles that spray a seawater at different levels in the RPB device to ensure uniform wetting of the packing material in the rotating packed bed. In one embodiment, the spacing of the rings is at even intervals, such as from 3-inch (7.62 centimeters) to 10-inch (25.4 centimeters), or 6-inch (15.24 centimeters) intervals. In one embodiment, the number of spray nozzles on each ring can be selected to provide sufficient spray coverage, such as from 5 to 15 nozzles per ring. In one embodiment, each of the rings comprises multiple nozzles that are placed 30 to 45-degree angles apart, which provides for 8 to 12 nozzles per ring. The placement of 8 equally-spaced spray nozzles on one of the rings in the liquid distributor is shown in FIG. 5B.

In one embodiment, the spray nozzles are equally-sized, equally-spaced across a ring circumference of each of the multiple liquid rings, and the positioning of the spray nozzles is oriented to spray the fresh seawater evenly on the packing material.

In one embodiment, the rings in the liquid distributor have diameters that place them equidistant from the inner surface of the packing material in the RPB device. In one embodiment, the rings all have the same diameter. In one embodiment, the diameters of the rings vary across the length of the liquid distributor.

In one embodiment the liquid distributor is held stationary at the top by a housing for the RPB device, in such a way that the positioning of the liquid distributor does not interfere with the rotation of the rotating shaft or the packed bed in the RPB device.

In one embodiment, fresh seawater is supplied to the stationary liquid distributor by an inlet header pipe that serves as a fresh seawater supply line, at the top of the RPB device, as shown in FIG. 5A.

Hydrodynamic studies in RPB devices by Yan, Lin & Ruan, I&EC Res. 2012, 51, 10472 have shown that gas-side pressure drop in a RPB device is proportional to the gas flow rate in the RPB device and the revolutions per minute (RPM) of the rotation of the packing material in the RPB device. In one embodiment, the integrated system provides high seawater flowrates and strong inlet pressure to achieve uniform wetting of the packing material and effective scrubbing of the marine exhaust gas over a range of gas flow rates provided by the gas distributor. Since seawater supply is abundant, the flowrates of the seawater in the liquid distributor can be kept high, or even constantly high, regardless of swings in the gas flowrate of the quenched marine exhaust gas. The swings in the gas flowrate of the quenched marine exhaust gas can vary depending on the operation and loads on the engines on the ship, but the effective scrubbing of the marine exhaust gas is maintained. In one embodiment, the flowrates of the seawater in the liquid distributor are kept constant over a range of quenched marine exhaust gas flowrates through the gas distributor.

A key to the descriptions for the numbers used in the drawings is as follows.

| Part Number | Description |
|---|---|
| 100 | Integrated System (100) |
| 102 | Fresh Seawater Pump (102) |
| 103 | Fresh Seawater Injection Line (103) |
| 104 | Exhaust Gas Source (104) |
| 105 | Additional Fresh Seawater Injection Line (105) |
| 106 | Main Engine (106) |
| 107 | Hot Exhaust Gas Entry (107) |
| 108 | Auxiliary Engines (108) |
| 109 | Boiler Exhaust Gas (109) |
| 110 | Boiler (110) |
| 111 | Auxiliary Engine Exhaust Gas (111) |
| 112 | Venturi Quencher (112) |
| 113 | Cooled Two-phase Venturi Effluent (113) |
| 114 | Sump Water Return Pump (114) |
| 115 | Fresh Seawater Supply Line (115) |
| 116 | Air Supply Line (116) |
| 117 | Spent Seawater Effluent (117) |
| 118 | Spent Seawater Recycle Line (118) |
| 119 | Seawater Effluent (119) |
| 120 | Rotating Packed Bed Device (120) |
| 121 | Scrubbed/Cooled Exhaust Gas (121) |
| 122 | Exhaust Gas Finishing Unit (122) |
| 123 | Sludge Line (123) |
| 124 | Exhaust Fan (124) |
| 125 | Scrubbed Marine Exhaust Gas (125) |
| 126 | Steam Coil (126) |
| 128 | Demister Pad (128) |
| 130 | Centrifuge Separator (130) |
| 131 | CO₂ Exhaust Line (131) |
| 132 | Seawater Holding Tank (132) |
| 134 | Sludge Holding Tank (134) |
| 202 | Seawater Inlet (202) |
| 204 | Movable Plate (204) |
| 206 | Throat Area (206) |
| 208 | Flooded Elbow (208) |
| 216 | Bottom Drain (216) |
| 300 | Schematic Arrangement (300) |
| 310 | Circumferentially-Skirted RPB Device (310) |
| 320 | Elongated Skirt (320) |
| 324 | Rotating Shaft (324) |
| 400 | Exemplary System (400) |
| 402 | Housing (402) |
| 403 | Top Bearings (403) |
| 404 | Gas Outlet (404) |
| 405 | Bottom Bearings (405) |
| 406 | Spargers (406) |
| 412 | Fresh Seawater (412) |
| 414 | Packing Material (414) |
| 416 | Wash Water Spray System (416) |
| 418 | Spray Nozzle (418) |
| 422 | Sparged Air (422) |
| 426 | Spent Seawater Sump (426) |
| 432 | Rotating Drive Motor (432) |
| 434 | Stationary Liquid Distributor (434) |
| 436 | Tangential Gas Entry (436) |
| 438 | Venturi Effluent Liquid (438) |
| 442 | RPB Effluent Liquid (442) |
| 536 | Liquid Ring (536) |
| 600 | Exemplary-Demister Pad (600) |
| 602 | Coalescing Vanes (602) |
| 604 | Support (604) |
| 700 | Circular Mist Eliminator (700) |
| 702 | Gas Inlet (702) |
| 704 | Demisted Gas Outlet (704) |

One example of the integrated system of this disclosure is shown in FIG. 1. As shown in FIG. 1, in this embodiment, a fresh seawater pump (102) feeds fresh seawater through a fresh seawater injection line (103) to a Venturi quencher (112), via a fresh seawater supply line (115), and to a rotating packed bed device (120). An exhaust gas source (104) comprising a main engine (106), auxiliary engines (108), and a boiler (110) collectively feed marine exhaust gas via a hot exhaust gas entry (107) to the Venturi quencher (112). In addition to marine exhaust gas from the main engine (106), boiler exhaust gas (109) and auxiliary engine exhaust gas (111) are also fed to the Venturi quencher (112). An additional fresh seawater injection line (105) feeds fresh seawater to a spent seawater effluent (117) exiting the rotating packed bed device (120) and the Venturi quencher (112). A sump water return pump (114) located between the Venturi quencher (112) and the rotating packed bed device (120) supplies a spent seawater recycle line (118) to the Venturi quencher (112) with spent seawater from the rotating packed bed device (120). A cooled two-phase Venturi effluent (113) from the Venturi quencher (112) is fed to the rotating packed bed device (120) using a stationary gas distributor (not shown in this figure). An air supply line (116) supplies air to the rotating packed bed device (120). A scrubbed/cooled exhaust gas (121) exits from the top of the rotating packed bed device (120) and passes to a exhaust gas finishing unit (122) that comprises a demister pad (128), a steam coil (126), and an exhaust fan (124). A scrubbed marine exhaust gas (125) is discharged from the ship to the atmosphere. The spent seawater effluent (117) from the Venturi quencher (112) and the rotating packed bed device (120) is sent to a centrifuge separator (130) that separates the spent seawater effluent (117) into three fractions, a CO2 fraction that is released to the atmosphere via a CO2 exhaust line (131), a seawater effluent (119) that is fed to a seawater holding tank (132), and a sludge line (123) that feeds a heavier fraction with concentrated particulates, or sludge, to a sludge holding tank (134).

FIG. 2 shows an example of a Venturi quencher (112) with a hot exhaust gas entry (107) at the top. The Venturi quencher (112) has two liquid inlets, with only one seawater inlet (202) clearly shown. The one seawater inlet (202) that is shown conveys fresh seawater and the other seawater inlet that is not clearly shown conveys spent seawater recycle. The inlets create one or more sprays of quench water along an upper conversing section of the Venturi quencher (112). A movable plate (204) is used to create a variable sized throat area (206) that can handle varied volumes of the marine exhaust gas that is fed to the hot exhaust gas entry (107). The bottom of the Venturi quencher (112) has a flooded elbow (208) that connects to a downstream rotating packed bed device. Beneath the flooded elbow (208) is a conical liquid collector with a bottom drain (216).

FIG. 3A is a schematic arrangement (300) of a Venturi quencher (112) with a rotating packed bed device (120) that can be used in an embodiment of this disclosure. Two liquid inlets that feed quench water are shown on the Venturi quencher (112), a first inlet that connects to a spent seawater recycle line (118) and a second seawater inlet (202) that feeds fresh seawater. The hot exhaust gas entry (107) is at the top of the Venturi quencher (112). There is a bottom drain (216) at the bottom of a conical liquid collector on the Venturi quencher (112). The Venturi quencher (112) is connected to the rotating packed bed device (120) with a flooded elbow that provides a tangential entry of a cooled two-phase mixture into a stationary gas distributor (not shown in this figure) around the outer circumference of the rotating packed bed device (120). The rotating packed bed device (120) produces a scrubbed/cooled exhaust gas (121) that exits from the top. Two liquid streams exit the bottom of the rotating packed bed device (120), a spent seawater effluent (117) and a spent seawater recycle that passes through a spent seawater recycle line (118) back to the Venturi quencher (112).

FIG. 3B-1 is an example of a top plan view of a circumferentially-skirted RPB device (310). A tangential gas entry (436) feeds a cooled two-phase mixture into an elongated skirt (320) that serves as the stationary gas distributor that distributes the quenched marine exhaust gas to the outside of packing material (414). Inside the packing material (414) is the stationary liquid distributor (434). At the center of the RPB device is a rotating shaft (324) that rotates the packed bed holding the packing material (414). The design of the tangential gas entry (436) provides a gas flow direction that is co-current with a rotating direction of the rotating packed bed.

FIG. 3B-2 shows additional details of an elongated skirt (320) used as a stationary gas distributor having a tangential gas entry (436) that distributes the quenched marine exhaust gas to the outside of the packing material in the rotating packed bed device.

FIG. 4 is an example of one embodiment of the integrated system of this disclosure, showing more details regarding the rotating packed bed device (120). A housing (402) surrounds the rotating packed bed device (120). A tangential gas entry (436) passes through a flooded elbow (208) into the device via a stationary gas distributor (not shown). The quenched marine exhaust gas is uniformly distributed along the outer circumference of the rotating packed bed device. The quenched marine exhaust gas passes across the width of the packing material (414) towards the center of the rotating packed bed device. Although a single passage is shown in the figure, the quenched marine exhaust gas passes across the length of the packed bed that holds the packing material (414). Venturi effluent liquid (438) is fed into the rotating packed bed device and flows down the side without contacting the packing material (414). Venturi effluent liquid (438) is collected in a spent seawater sump (426) towards the bottom. A stationary liquid distributor (434) is positioned at the center of the rotating packed bed device. Fresh seawater (412) is fed via a fresh seawater supply line (115) into the stationary liquid distributor (434). The stationary liquid distributor (434) has multiple liquid rings along its length. The multiple liquid rings are fitted with spray nozzles (418) that spray the fresh seawater (412) along an inner circumference of the rotating packed bed device. The fresh seawater (412) outwardly passes through the packing material (414) and the RPB effluent liquid (442) is collected in the spent seawater sump (426). A rotating drive motor (432) at the bottom and center of the rotating packed bed device (120) drives the rotating shaft (324) that rotates the rotating packed bed of the packing material (414). The rotating drive motor (432) is fixed to the rotating shaft (324) within the rotating packed bed device. The rotating shaft (324) supports the bottom of the packed bed of the packing material (414) but does not go through the eye of the rotating packed bed device. The outer periphery of the packed bed in the rotating packed bed device is steadied and supported by a set of top bearings (403) that keep the packed bed centered at the top. One or more bottom bearings (405), e.g., roller bearings, support the rotating shaft (324) above the rotating drive motor (432). A wash water spray system (416) sprays a wash solution to the outer areas of the packing material (414) in the rotating packed bed. The used wash solution with loosened soot and particulates drops into the spent seawater sump (426). Scrubbed/cooled exhaust gas (121) passes up towards a gas outlet (404) at the top of the rotating packed bed device (120). Before being released to the atmosphere the scrubbed/cooled exhaust gas (121) passes through a demister pad (128) and one or more steam coils (126). Scrubbed marine exhaust gas (125) exits to the atmosphere. The spent seawater sump (426) is supplied with air via an air supply line (116). The air supply line (116) is fitted with spargers (406) that create sparged air (422) into the collected liquid in the spent seawater sump (426). Outlets at the bottom of the spent seawater sump (426) release spent seawater effluent (117) and feed spent seawater via a spent seawater recycle line (118).

FIG. 5A is an elevation view of embodiment of a stationary liquid distributor (434) having liquid rings (536) arranged in series with each liquid ring (536) fitted with multiple spray nozzles (418). The liquid rings (536) are evenly spaced to fit across a length of a rotating packed bed. The stationary liquid distributor (434) is supplied with fresh seawater (412) via a fresh seawater supply line (115).

FIG. 5B is a top plan view of one of the liquid rings (536) in an exemplary stationary liquid distributor (434). The liquid ring (536) is circular and has spray nozzles (418) that are equally-sized and equally-spaced across the ring circumference with the spray nozzles (418) directed outwardly.

FIG. 6 is an exemplary-demister pad (600) that is circular, with coalescing vanes (602) that are held by a support (604).

FIG. 7 shows a circular mist eliminator (700) that is fitted with steam coils (126). A gas inlet (702) feeds exhaust gas to the center of the circular mist eliminator (700) and a demisted gas outlet (704) discharges treated exhaust gas from the circular mist eliminator (700).

The transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

For the purposes of this specification and appended claims, unless otherwise indicated, all numbers expressing quantities, percentages or proportions, and other numerical values used in the specification and claims, are to be understood as being modified in all instances by the term “about.” Furthermore, all ranges disclosed herein are inclusive of the endpoints and are independently combinable. Whenever a numerical range with a lower limit and an upper limit are disclosed, any number falling within the range is also specifically disclosed. Unless otherwise specified, all percentages are in weight percent.

Any term, abbreviation or shorthand not defined is understood to have the ordinary meaning used by a person skilled in the art at the time the application is filed. The singular forms “a,” “an,” and “the,” include plural references unless expressly and unequivocally limited to one instance.

All the publications, patents and patent applications cited in this application are herein incorporated by reference in their entirety to the same extent as if the disclosure of each individual publication, patent application or patent was specifically and individually indicated to be incorporated by reference in its entirety.

This written description uses examples to disclose the invention, including the best mode, and also to enable any person skilled in the art to make and use the invention. Many modifications of the exemplary embodiments of the invention disclosed above will readily occur to those skilled in the art. Accordingly, the invention is to be construed as including all structure and methods that fall within the scope of the appended claims. Unless otherwise specified, the recitation of a genus of elements, materials or other components, from which an individual component or mixture of components can be selected, is intended to include all possible sub-generic combinations of the listed components and mixtures thereof

The invention illustratively disclosed herein suitably may be practiced in the absence of any element which is not specifically disclosed herein.

It is claimed:

1. An integrated system for onboard scrubbing of a marine exhaust gas on a ship, comprising:
a) a Venturi quencher having:
i) two liquid inlets that feed a quench water to the Venturi quencher, wherein a first liquid inlet connects to a spent seawater recycle line that feeds the quench water that is comprised of a recycled water from a spent seawater sump of a rotating packed bed device and wherein a second liquid inlet connects to a fresh seawater supply line that feeds the quench water that comprises a fresh seawater; and
ii) a hot exhaust gas entry that feeds the marine exhaust gas, having a temperature greater than 180° C., from an engine on the ship; and
b) the rotating packed bed device, having:
iii) a stationary gas distributor, placed along an outer circumference of the rotating packed bed device, connected to the Venturi quencher, wherein the stationary gas distributor is configured to receive a cooled two-phase mixture of the marine exhaust gas and the quench water from the Venturi quencher, disengage a quenched marine exhaust gas from the cooled two-phase mixture, and uniformly distribute the quenched marine exhaust gas along the outer circumference of the rotating packed bed device; and
iv) a stationary liquid distributor, with multiple liquid rings, that is centrally positioned within the rotating packed bed device, wherein the multiple liquid rings are fitted with spray nozzles that spray a seawater along an inner circumference of the rotating packed bed device.

2. The integrated system of claim 1, wherein the Venturi quencher and the rotating packed bed device are configured to remove particulates and sulfur oxides.

3. The integrated system of claim 1, wherein the Venturi quencher comprises a variable sized throat that handles varied volumes of the marine exhaust gas.

4. The integrated system of claim 1, wherein the Venturi quencher comprises a flooded elbow that connects to the rotating packed bed device and provides a tangential entry of the cooled two-phase mixture into the stationary gas distributor.

5. The integrated system of claim 1, additionally comprising a bottom drain on the Venturi quencher that drains a slipstream of particulates and liquid from a bottom of a flooded elbow of the Venturi quencher.

6. The integrated system of claim 1, wherein a connection between the Venturi quencher and the rotating packed bed device utilizes a tangential gas entry that disengages the quenched marine exhaust gas from the quench water.

7. The integrated system of claim 6, wherein a design of the tangential gas entry provides a gas flow direction that is co-current with a rotating direction of the rotating packed bed device.

8. The integrated system of claim 1, wherein the two liquid inlets create one or more sprays of the quench water along an upper converging section of the Venturi quencher.

9. The integrated system of claim 1, wherein the Venturi quencher is configured to cause the marine exhaust gas to contact the recycled water before the marine exhaust gas is contacted by the fresh seawater.

10. The integrated system of claim 1, wherein the stationary gas distributor extends along a majority of the outer circumference and is an elongated skirt that causes the quench water to drop out of the cooled two-phase mixture while the quenched marine exhaust gas is raised up and enters a packing in a packed bed in the rotating packed bed device.

11. The integrated system of claim 1, wherein the spent seawater sump is provided with an air supply line through which air is sparged into collected liquids, and the spent seawater sump collects the quench water from the Venturi quencher, an effluent liquid from the rotating packed bed device, or a combination thereof, and the spent seawater sump creates stable sulfates in the collected liquids in the spent seawater sump.

12. The integrated system of claim 1, wherein the stationary liquid distributor is stationary relative to a rotating packed bed and is supported from a top of the rotating packed bed device by a housing such that a positioning of the stationary liquid distributor does not interfere with a rotation of a rotating shaft in the rotating packed bed device.

13. The integrated system of claim 1, wherein the multiple liquid rings are arranged in series, are evenly spaced across a length of a packed bed, and have diameters that place them equidistant from an inner surface of a packing material in the rotating packed bed device.

14. The integrated system of claim 13, wherein the spray nozzles are equally-sized, equally-spaced across a ring circumference of each of the multiple liquid rings, and the spray nozzles are oriented to spray the fresh seawater evenly on the packing material.

15. The integrated system of claim 1, wherein the rotating packed bed device has a ratio of an outer diameter to an inner diameter of a packed bed in the rotating packed bed device that is 2.3:1 or less.

16. The integrated system of claim 1, additionally comprising one or more mist eliminators fitted at a gas outlet on the rotating packed bed device.

17. A process for onboard scrubbing of the marine exhaust gas on the ship, comprising feeding the marine exhaust gas to the integrated system of claim 1 and discharging a scrubbed marine exhaust gas to an atmosphere.

18. The process of claim 17, wherein the marine exhaust gas is aggregated from multiple engines and a boiler on the ship.

19. The process of claim 17, wherein the Venturi quencher traps particulates larger than 3 microns in average diameter, and the rotating packed bed device comprises a packing material that traps sub-micron particulates.

20. The process of claim 17, wherein a bulk of a sulfur dioxide mass transfer between the quenched marine exhaust gas and the seawater occur in inner areas of a packed bed in the rotating packed bed device, and a second bulk of a trapping of sub-micron particulates occurs in outer areas of the packed bed.

21. The process of claim 17, wherein a cascade of the recycled water from the spent seawater sump through the Venturi quencher is maximized and the fresh seawater is used principally for controlling a level of liquid collected in the spent seawater sump.

22. The process of claim 17, wherein as the recycled water from the spent seawater sump is passed through the Venturi quencher, the recycled water is heated, and stable sulfates are retained in the recycled water that is heated.

23. A marine ship, comprising the integrated system of claim 1.
